(19) United States
(12) Patent Application Publication
(10) Pub. No.: US 2001/0051926 A1
(43) Pub. Date: Dec. 13, 2001

(54) Method for safely encrypting transmission data

(75) Inventor: Ching-Feng Wang, TaiNan (TW)

Correspondence Address: DOUGHERTY & TROXELL, SUITE 1404, 5205 LEESBURG PIKE, FALLS CHURCH, VA, 22041, US

(73) Assignee: TelePaq Technology Inc.

(21) Appl. No.: 09/865,714

(22) Filed: May 29, 2001

(30) Foreign Application Priority Data
May 30, 2000 (TW) 89110438

(51) Int. Cl. H04L 9/00

(52) U.S. Cl. 705/51; 713/162

(57) ABSTRACT

A method for safely encrypting transmission data is disclosed. The method can be used in a personal digital assistant (PDA) or a mobile phone handset for connecting to a network to download data. An access device serves to be connected to a network, and a series number is used as encrypting key. Thus, the data acquired from a network is encrypted. For the users to download data, the download data is only used through the access device of the user, other users can not use the data. Therefore, the objects of paying fees by users and encrypting transferring data are achieved.

### FIELD OF THE INVENTION

The present invention relates to a method for safely encrypting transmission data, which is applied on a personal digital assistant (PDA) or a mobile phone handset for capturing data.

### BACKGROUND OF THE INVENTION

With the application of the Internet, the electronic commerce is widely used and discussed. Especially, the connection of wireless handsets and personal digital assistant (PDA) to a network is a trend. The manufacturer of handset and PDA make their best in the development of novel handsets for being applied to the connection of a network through wireless transmission. For example, the current wireless application protocol (WAP) is widely used in the connection of a handset to a network. The related products are popular in the market. Therefore, to wirelessly capturing data through a handset or a PDA is a trend and is widely used recently.

However, the current way for wireless capturing data through an Internet has no function of encryption. Referring to FIG. 1, a schematic view showing that a user acquires data from an Internet by a prior art way. As shown in FIG. 1, the subscriber's end 10 is to download data on a network 30. In general, the data is downloaded through an Internet directly. After downloading, the data is transferred to other peoples.

That is, any one may download data or a member acquired a password or an encrypting code can download data. However, in the aforementioned process of being connected to a network for acquiring data, no way can be used to confine the user to download data repeatedly. That is, it is possible that one download data is used by many people. Therefore, this is unfair to the original creator and disobeys the rule of wisdom asset. Consequently, this condition is necessary to be improved.

Therefore, there is an eager demand for a method for safely encrypting transmission data, which can be used in the Internet. The download data is only used by specific users and can not be transferred to other peoples. Thus, the data is encrypted effectively.

### SUMMARY OF THE INVENTION

Accordingly, the primary object of the present invention is to provide a method for safely encrypting transmission data, which is used in a personal digital assistant (PDA) or a mobile phone handset for wirelessly capturing data. The primary object of the present invention is to a safety encrypting method. After the user downloads data from a network, the data is encrypted and then is transferred to the user. The user decrypts the data through a player or an access device for playing the data downloading from a network. The described access device is for example an MP3 music database, an electronic book, a network theater, etc.

In the encryption way of the present invention, the general series number is used as an encrypting key in the encryption, or further identification number or the registering number of a company can be used. The encrypting key is only used by the access device of the user for decrypting the encrypted data. That is, the download data of the user is only used by that user, which can not be transferred to other peoples so as to protect the right of the original creator.

To achieve aforesaid object, the present invention provides a method for safely encrypting transmission data, wherein an access device serves to be connected to the subscriber's end of a network, and the series number of the access device is used as encrypting key. Thus, the data acquired from a network is encrypted. For the users to download data, the download data is only used through the access device of the user, other user can not use the data. Therefore, the objects of paying fees by users and encrypting transferring data are achieved.

Preferably, a method for safely encrypting transmission data is used in the playing of MP3 music through a network. By connecting through an access device, the series number of the access device being used as an encrypting key for decrypting the encrypting data. The user at first inputs required data and series number; by a servo of a network. Data of music in a database is downloaded and then is encrypted. Then the data is transferred back to the user. Then, the user downloads the data to an MP3 player for playing the music.

Preferably, a method for safely encrypting transmission data is used in the playing of electronic book through a network. By connecting through an access device, the series number of the access device being used as an encrypting key for decrypting the encrypting data. The user at first inputs required data and series number. By a servo of a network, data of an electronic book in a database is downloaded and then is encrypted. Then the data is transferred back to the user. Then, the user downloads the data to an electronic book player for playing contents of the electronic book.

The various objects and advantages of the present invention will be more readily understood from the following detailed description when read in conjunction with the appended drawing.

### BRIEF DESCRIPTION OF DRAWINGS

FIG. 1 is a schematic view for capturing data from an Internet by a user in the prior art design.

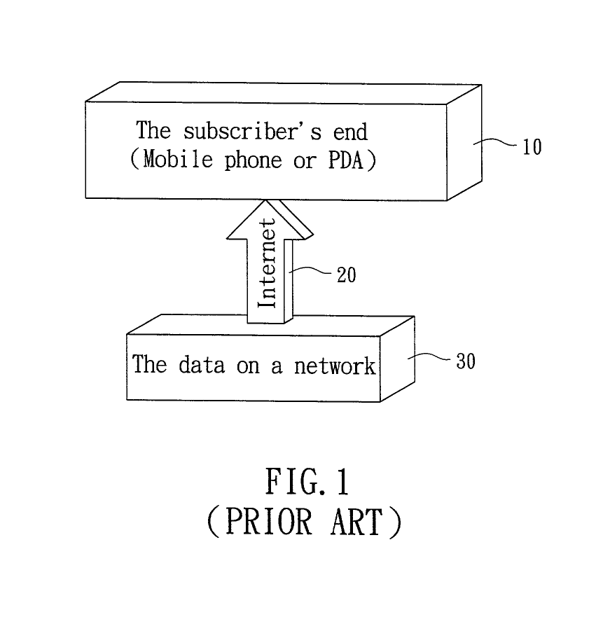

FIG. 2 is a schematic view showing the concept for encrypting the transferring data of a network in the embodiment of the present invention.

FIG. 3 is a flow diagram showing the process and use for the transferring data of the network in the embodiment of the present invention.

FIG. 4 is a schematic view showing an embodiment that the method for safely encrypting transmission data of the present invention is used in the playing of the network MP3 music.

FIG. 5 is a schematic view showing an embodiment that the method for safely encrypting transmission data of the present invention is used in the playing of the network electronic book.

### DETAILED DESCRIPTION OF THE PREFERRED EMBODIMENT

The present invention relates to a method for safely encrypting transmission data, which is primary used in a personal digital assistant (PDA) and a handset used in mobile phone. Through the present invention, a method for safety encryption is provided, after the user downloads data from a network, the data is encrypted and then is transferred to the user. The user decrypts the data through a player or an access device for playing the data downloading from a network. The described access device is for example an MP3 music database, an electronic book, a network theater, etc.

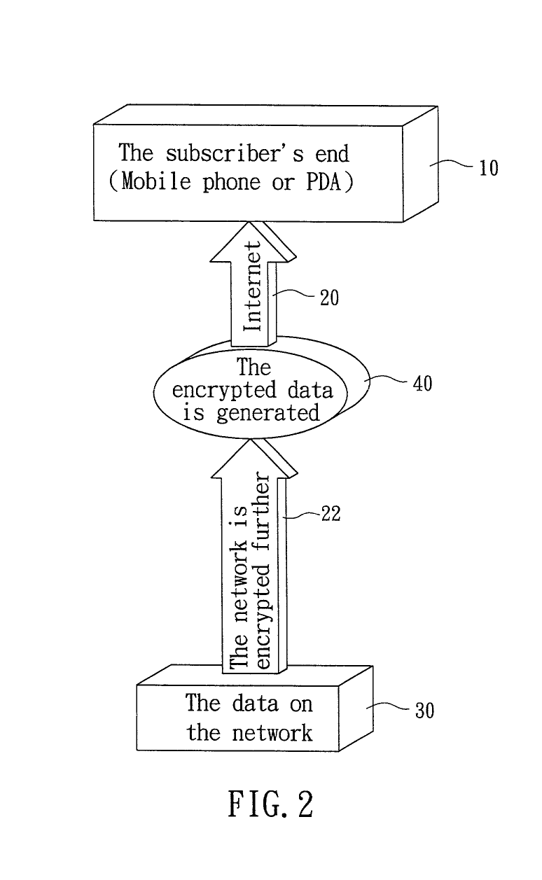

Referring to FIG. 2, a schematic view showing the concept about the method for safely encrypting transmission data of the present invention is illustrated herein. In that, the data 30 in the network is encrypted further (22). Then encrypted data is generated (40). Then, the data is transferred to the subscriber's end 10 through an Internet 20. The subscriber's end 10 is for example a handset of a mobile phone, or a personal digital assistant (PDA) which can captures the data from the network directly without needing to be connected to a computer. Therefore, it is matched to the requirement of a late PC age, i.e. an age of no PC. The work of networking is only performed through a PDA.

In order to realize the aforesaid encryption work, in the present invention, the user's access device is connected to the subscriber's end of the network. The series number of the access device is used as an encrypting key for encrypting data of networks so that the encrypted data can be downloaded only by the access device with the specific series number. Other end users without being connected to this access device can not use these data. The access device is an network connecting device for data transmission used by networks, which may be for example an MP3 music player or an electronic book which can downloaded data or upload data to the network for being used by specific users. Therefore, the access device is not confined to the use of PC, which can be personal digital assistants (PDA) or handsets.

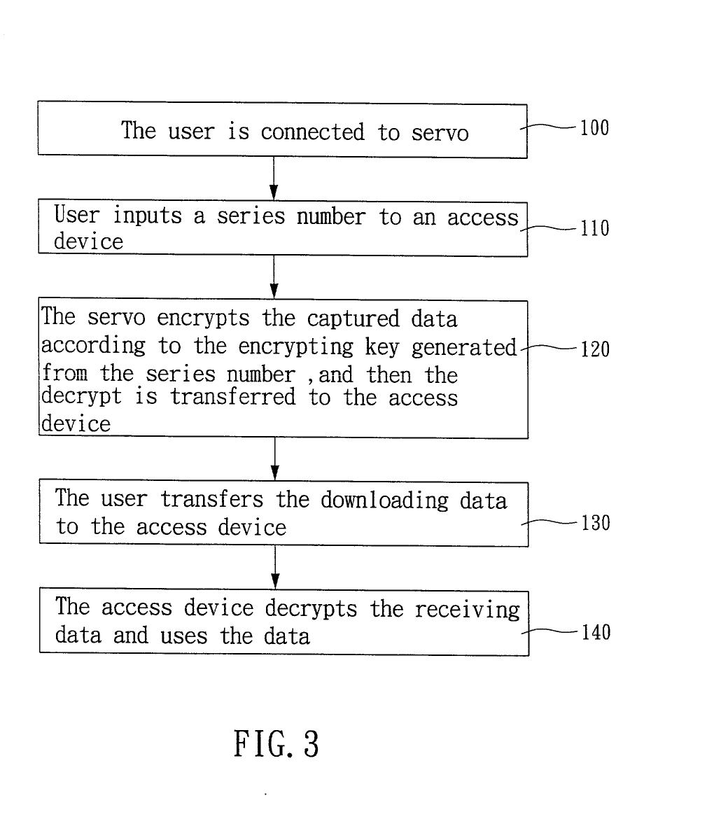

The method for safely encrypting transmission data in the present invention is illustrated in FIG. 3. The FIG. 3 shows an embodiment of the present invention which is a process about the method for safely encrypting transmission data. The user is connected to a servo (step 100). Then, user inputs a series number to an access device (step 110). The servo encrypts the captured data according to the encrypting key generated from the series number, and then the decrypt is transferred to the access device (step 120). The user transfers the downloading data to the access device 130 himself (or herself). Then, the access device decrypts the receiving data and uses the data (step 140). By the aforesaid steps, the data transferred in the network is encrypted. The decryption is performed by only specific access devices for being used. Therefore, the effect of encryption in a network is achieved.

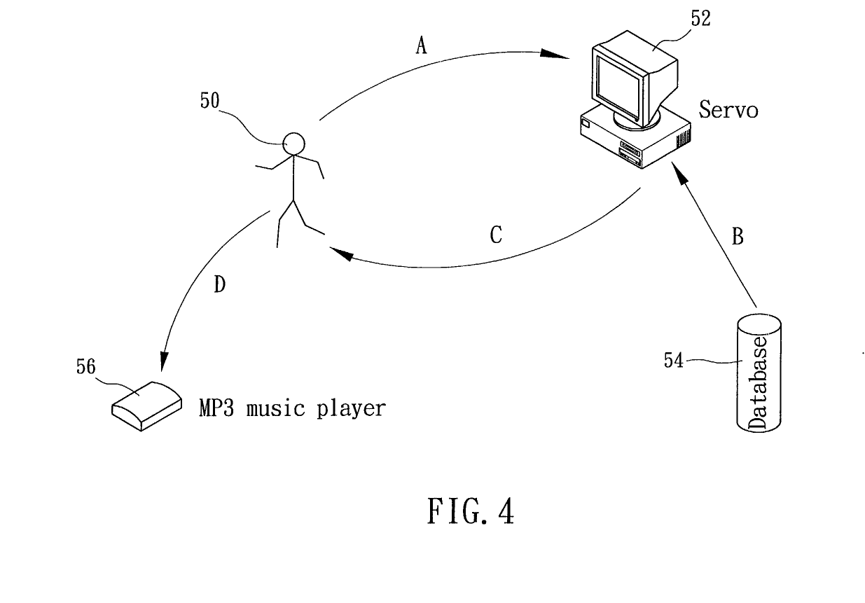

The method for safely encrypting transmission data in the present invention can be used in the playing the MP3 music. About this, referring to FIG. 4, a schematic view about an embodiment that the encrypting method of the present invention is used to the playing of MP3 music is illustrated herein. In this embodiment, the user 50 is a connection using an access device the series number of the access device (S/N) is used an encrypting key for network encryption. The access device is a MP3 music player 56.

With reference to FIG. 4, the user 50 at first inputs the required data and the series number (arrow A). By the servo 52, the data in the database 54 is downloaded (arrow B). Then, the data is encrypted according to the series number and then is transferred back to the user 50 (arrow C). Then, the user 50 downloads the data to a MP3 player 56 (arrow D) for playing music about the data. Therefore, the encrypting method of the present invention applied to an MP3 player is accomplished. The aforesaid access device may be a network connecting device for transferring data used in a network. The data can be downloaded or uploaded to a network for being used by specific users.

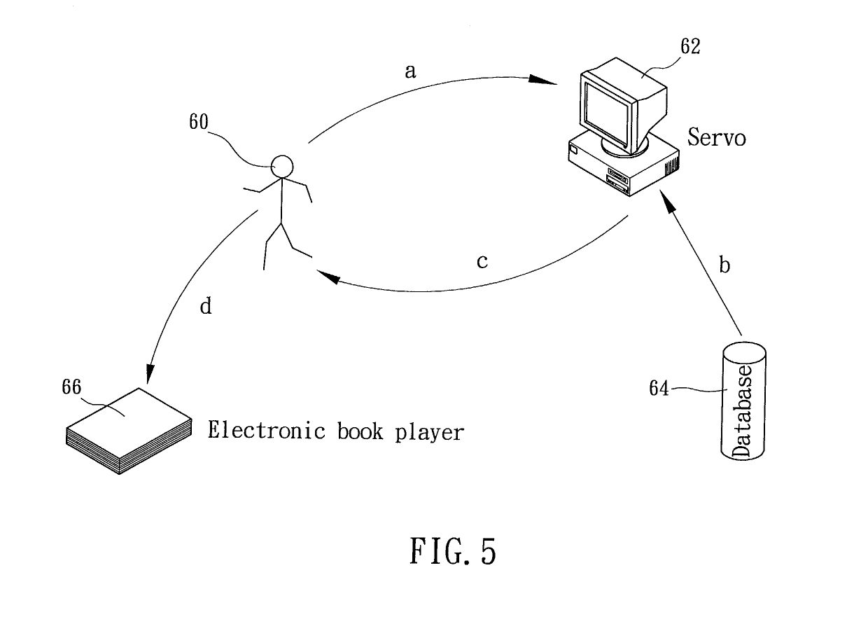

Similarly, the method of the present invention can be further used to the data encryption of the electronic book in an Internet, as illustrated in FIG. 5. In FIG. 5, the user 60 in advance inputs the required data and series number (arrow a). By a servo 62 in the network, the electronic book in the database 64 is downloaded (arrow b), and then the data is encrypted according to the series number and then is transferred to the user 60 (arrow c). Then, the user downloads these data to an electronic book player 66 for decrypting the data for playing the content of the electronic book. Similarly, the access device is a network connecting device for data transfer used in general networks, which can download data or upload data to a network for being used by specific users.

In summary, the method for safely encrypting transmission data of the present invention provides the function of encrypting the transferring data through Internet for avoiding that the data is downloaded once but being used by many peoples through many times. Therefore, the object of paying fees by users is achieved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for safely encrypting transmission data, wherein an access device is connected to the subscriber's end of a network, a series number (S/N) in the access device is used as an encrypting key for encrypting data from said network so that the encrypting data is only downloaded by an access device having said series number, while other users without connecting to said access device can not use said encrypting data.

2. The method for safely encrypting transmission data as claimed in claim 1, wherein said access device is a network connecting device for data transmission used in a network, said access device serves to download data from a network or upload data to a network for being used by specific users.

3. The method for safely encrypting transmission data as claimed in claim 1, wherein said method is used in playing of MP3 music, the user at first inputs required data and series number; by a servo, data of a music in a database is downloaded and then is encrypted; then said data is transferred back to said user; then, said user downloads said data to an MP3 player for playing said music.

4. The method for safely encrypting transmission data as claimed in claim 1, wherein said method is used in the playing of an electronic book, the user at first inputs required data and series number; by a servo, data of an electronic book in a database is downloaded and then is encrypted; then said data is transferred back to said user; then, said user downloads said data to an electronic book player for playing contents in said electronic book.

5. A method for safely encrypting transmission data comprising steps of:
connecting to a network through an accessing device and then further connecting to a servo;
inputting a series number of said access device as an encrypting key;
downloading required data from said network and then encrypting said data according to said encrypting key; and then transferring the encrypted data to a user;
transferring the encrypted data to an access device of the user; and
receiving said encrypted data by said access device and then decrypting said received encrypted data for being used;
wherein in above steps, said data transferred in said network is encrypted, and said encrypted data is decrypted by a access device assigned by said series number.

6. The method for safely encrypting transmission data as claimed in claim 5, wherein said access device is a network connecting device for data transmission used in a network, said access device serves to download data from a network or upload data to a network for being used by specific users.

7. A method for safely encrypting transmission data used in playing MP3 music through a network; by connecting through an access device, said series number of said access device being used as an encrypting key for decrypting said encrypting data; wherein the user at first inputs required data and a series number; by a servo of a network, data of a music in a database is downloaded and then is encrypted; then said data is transferred back to said user; then, said user downloads said data to an MP3 player for playing said music.

8. The method for safely encrypting transmission data as claimed in claim 7, wherein said access device is a network connecting device for data transmission used in a network, said access device serves to download data from a network or upload data to a network for being used by specific users.

9. A method for safely encrypting transmission data used in playing contents of an electronic book through a network; by connecting through an access device, said series number of said access device being used as an encrypting key for decrypting said encrypting data; wherein the user at first inputs required data and a series number; by a servo of a network, data of an electronic book in a database is downloaded and then is encrypted; then said data is transferred back to said user; then, said user downloads said data to an electronic book player for playing contents of said electronic book.

10. The method for safely encrypting transmission data as claimed in claim 9, wherein said access device is a network connecting device for data transmission used in a network, said access device serves to download data from a network or upload data to a network for being used by specific users.
